(19) United States
(12) Patent Application Publication
(10) Pub. No.: US 2026/0319958 A1
(43) Pub. Date: Oct. 15, 2026

(54) APPLICATION SHARED MEMORY FOR MICRONAUT CACHE

(71) Applicant: Oracle International Corporation, Redwood Shores, CA (US)

(72) Inventors: Entiol Liko, Zurich (CH); Arash Kazemi Koohbanani, Zurich (CH); Aleksei Kashuba, Zurich (CH); Noman Ahmed Sheikh, Zurich (CH); Alexander Ulrich, Freiburg (DE); Andrew Brownsword, Vancouver (CA); Eric Sedlar, Portola Valley, CA (US); Matthias Neugschwandtner, Perchtoldsdorf (AU)

(21) Appl. No.: 19/239,616

(22) Filed: Jun. 16, 2025

Related U.S. Application Data
(60) Provisional application No. 63/788,490, filed on Apr. 14, 2025.

(51) Int. Cl. G06F 12/084; G06F 9/30; G06F 12/0893

(52) U.S. Cl. CPC G06F 12/084; G06F 9/30047; G06F 12/0893

(57) ABSTRACT

Mechanisms are provided for implementing a shared memory segment-based (SMS) cache that improves performance of isolated application instances with regard to startup times and horizontal scaling. A plurality of application instances are executed in a cloud computing environment runtime, where each instance executes in an isolated manner from each other instance. A shared memory segment (SMS) for caching data used by the plurality of application instances is allocated, and each application instance is attached to the SMS. A first application instance, via a first custom call to the cloud computing system runtime, stores data to a cache implemented in the shared memory segment. A second application instance retrieves, via a second custom call to the cloud computing system runtime, cached data from the cache without accessing an original data source of the cached data.

### BENEFIT CLAIM

This application claims the benefit under 35 U.S.C. § 119(e) of provisional application 63/788,490, filed Apr. 14, 2025, by Liko et al., the entire contents of which is hereby incorporated by reference. The applicant hereby rescinds any disclaimer of claim scope in the parent applications or the prosecution history thereof and advises the USPTO that the claims in this application may be broader than any claim in the parent application.

### FIELD OF THE INVENTION

The illustrative embodiments of the present invention relate to mechanisms for improving the startup time and horizontal scaling of serverless applications. More specifically, the illustrative embodiments related to a framework for caching data for reuse by multiple different isolated application instances of the same application in a serverless cloud computing environment using shared memory segments to implement the cache.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Caching is a technique used in computer systems to improve performance by temporarily storing copies of frequently accessed data in a location that can be accessed more quickly than the original source. The cache plays a critical role in reducing latency, lowering the demand of underlying resources, and improving the overall efficiency of systems ranging from web servers to database management systems (DBMS) and modern hardware architectures. Caches can be implemented at various levels, including Central Processing Unit (CPU) caches for processing efficiency, in-memory caches for application performance, and content delivery network (CDN) caches for speeding up web content delivery.

Caching may also be used in a serverless cloud computing environment. Unlike conventional cloud computing models, where developers are responsible for provisioning and managing virtual machines or containers, serverless computing abstracts away the underlying infrastructure entirely, allowing developers to focus solely on writing code while the cloud provider automatically handles scaling, resource allocation, and fault tolerance. By enabling event-driven execution of small, stateless functions, serverless architectures offer an elastic and highly scalable solution that adapts to demand in real-time.

In cloud computing, it is often the case of multiple instances of the same application requiring the same data for business logic. Caching of such data should provide better performance and a lower memory footprint. However, current caching solutions are fundamentally incompatible with stateless, short-lived functions. That is, current caching solutions require that a separate cache be created for each application instance and used by that particular application instance. This means that if there are multiple application instances of the same application, they will each have a separate cache which may store duplicate data. Since the average lifetime of a serverless application is very short (in the order of milliseconds or a few seconds), current caching solutions do not offer an adequate set of features for serverless cloud computing environments. That is, the overhead of creating and maintaining the separate caches, and the memory footprint due to the need to create separate caches for each application instance, may outweigh the performance improvement obtained from the short-lived application usage of the cache.

With current cache mechanisms, per-instance caches cannot share their data with other instances of the same application, which means that each instance will have an isolated copy of the same data. As noted above, this increases the memory footprint of the application instances as a whole.

### BRIEF DESCRIPTION OF THE DRAWINGS

In the drawings:

FIG. 1 is an example block diagram illustrating an example GraalOS configuration in accordance with one illustrative embodiment;

FIG. 2 is an example block diagram of a shared memory segment-based cache for a serverless cloud computing environment in accordance with one illustrative embodiment;

FIG. 3 is an example block diagram of a Micronaut based architecture in accordance with one illustrative embodiment;

FIG. 4 is an example diagram of a Micronaut based cache usage example in accordance with one illustrative embodiment;

FIG. 5 is an example diagram of a SyncCache interface in accordance with one illustrative embodiment;

FIG. 6 shows an example overview of a GraalOS-In-DB configuration in accordance with one illustrative embodiment;

FIG. 7 shows an example process for initialization of a shared memory segment based cache in accordance with one illustrative embodiment;

FIG. 8 shows an example block diagram of an overall architecture of the SMS cache in accordance with one illustrative embodiment;

FIG. 9 shows an example of an initial design structure for a shared memory segment (SMS) that can be used to provide the SMS cache in accordance with one illustrative embodiment;

FIGS. 10A and 10B illustrate an example of improvements to the shared memory segment-based cache in accordance with one illustrative embodiment;

FIG. 11 shows the change in operations performed when using the GraalVM internal representation as the format;

FIG. 12 shows an example usage of MPKs in accordance with one or more illustrative embodiments;

FIG. 13 is a flowchart outlining an example operation for implementing a shared memory segment based cache in accordance with one illustrative embodiment;

FIG. 14 is a block diagram that illustrates a computer system upon which an embodiment of the invention may be implemented; and

FIG. 15 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

As noted above, caching is a technology that can greatly improve the performance of computing systems. However, current caching technology does not permit sharing of data of a cache between isolated application instances (or “Isolates”) in a serverless cloud computing environment or runtime. A shared memory caching solution may be used to share the cached data between different application instances, however such a solution may introduce overhead from serialization (conversion of an object into a byte stream), deserialization (conversion of a byte stream back into a corresponding object), and network communication. This increases the startup time and lowers the overall throughput of the system.

The illustrative embodiments provide mechanisms for fast horizontal scaling and startup of serverless cloud computing system workloads by caching frequently accessed data in a shared memory segment-based cache that is shared amongst application instances of a corresponding application. With the illustrative embodiments, the serverless runtime is responsible for providing a pointer to a shared memory segment, and for providing access to the shared memory segment for all application instances of the same application that are sharing that shared memory segment. Mechanisms are provided for the shared memory segment to implement a cache for data that is reused by the application instances sharing the shared memory segment. Different applications, and their application instances, may have different shared memory segments that implement corresponding caches in accordance with the illustrative embodiments, such that instances of application A have a shared memory segment-based cache X and instances of application B have a shared memory segment-based cache Y, for example. This improves start-up time for application instances, as well as the overall throughput of the computing system.

The illustrative embodiments provide shared memory capabilities with the performance of an in-process cache. This removes the replication of the data between application instances since the data is cached and shared amongst the application instances, and allows for improved scaling since the amount of data is not related to the number of application instances. The illustrative embodiments further improve throughput since there is no “over-the-network” access required for accessing the data which resides in the shared memory segment-based cache, e.g., once one application instance caches the data in the shared memory segment-based cache, the other application instances for that application may access the data directly from the shared memory segment-based cache without having to go “over-the-network” to access the data from the original source, e.g., a database management system (DBMS) or the like.

### General Overview

In accordance with some illustrative embodiments, the overall architecture of the shared memory segment-based cache mechanism includes primary components of a serverless runtime environment and an application framework, as well as mechanisms for communicating between the runtime and the application framework to facilitate the creation and maintaining of a shared memory segment-based cache for application instances of an application. The serverless runtime provides a communication mechanism between the runtime and the application instances, as well as allocates and deallocates memory segments that are accessible from the different application instances. The serverless runtime further provides functionality for giving, to an application instance, access to a shared memory segment. Any serverless runtime that is modifiable to provide these functionalities may be used with the mechanisms of the illustrative embodiments, an example of which is the GraalOS runtime available from Oracle Corporation, and which will be used as a running example implementation in the following description for purposes of illustration.

The serverless runtime is able to communicate with application instances through the receiving of requests from the application instances and returning corresponding data. This can be achieved in a variety of different ways depending on the particular implementation desired, e.g., HyperText Transfer Protocol (HTTP) requests can be used, or more sophisticated mechanisms, such as Unix sockets or system calls (syscalls). In the case of a GraalOS runtime, the communication between the GraalOS runtime and the application instances can be performed using syscalls which are intercepted by GraalOS which uses an internal implementation for each syscall. This provides a way to add a custom call, e.g., a custom system call (syscall), that is customized so that internal features of the runtime can be exposed to the application instances, such as a pointer to the shared memory segment in the case of the present invention. To request the pointer to the shared memory segment, the application instance uses the custom syscall and receives back a variable of type long, representing the pointer to the shared memory segment.

The serverless runtime is further able to allocate and deallocate an amount of memory usable by the application instances. The serverless runtime is able to “attach” each application instance to this allocated amount of memory, i.e. the shared memory segment, where “attaching” an application instance refers to the application instance being given access to the specified portion of memory (shared memory segment), such that they can read from and write to this portion of memory. Thus, the serverless runtime provides the functionality for allocating and deallocated the shared memory segments, attaching application instances to the shared memory segments, and providing a custom communication mechanism through which the shared memory segment may be identified to, and accessed by, the application instances.

In addition to the above, in some illustrative embodiments, a web application framework is provided. While a cache can be used in any application, integrating the cache into existing applications often requires significant engineering efforts. In some illustrative embodiments a modular application/microservices framework, such as the Micronaut framework or the like, is used to generate an Application Programming Interface (API) for a custom cache. The API, in accordance with some illustrative embodiments, includes three primary functions: PUT(key, value) which caches the value using the provided key; GET(key) which returns the value cached with the specified key if it exists; and INVALIDATE(key) which removes the entry with the specified key from the cache if the entry exists. The API can be used by the application instances for caching of desired data to the shared memory segment-based cache. With the mechanisms of the illustrative embodiments, the shared memory segment-based cache is in-process which means that the application instances can use the provided API as a regular function call.

Many programming languages manage data through objects, and since the illustrative embodiments cache data for use by application instances in a serverless runtime computing environment, via a shared memory segment-based cache, mechanisms are provided for serializing the object (converting the object to a byte stream) and deserialize the byte stream back into the original object when the object is requested. In some illustrative embodiments, a Serialization/Deserialization (S/D) library may be used to serialize the object as a string in JSON or any other format and back as an object. Depending on the system more performant solutions may also be used, such as copying the raw representation of the object as-is in the cache during a PUT request. Since the cached data is going to be used by different application instances of the same application, it is not necessary to encode it in a format like JSON. Creating a copy of the object tree as is can significantly improve the performance, but requires a more tight integration with the serverless runtime than the S/D library implementation, and is very dependent on the underlying system. The most portable solution is with a S/D library.

Thus, in some illustrative embodiments, an application framework, such as a web application framework, and a serverless runtime computing environment configured for implementing a shared memory segment-based cache, are provided. The application framework provides an API to cache and request data from the shared memory segment-based cache. The shared memory segment-based cache handles the serialization and deserialization of the object. The application needs to request access to the shared memory segment from the serverless runtime, which is able to allocate and deallocate such shared memory segments. The serverless runtime, which provides the communication mechanism, gives access to the application instance and returns the pointer to the shared memory segment which holds the SMS cache. The pointer is used by the application instance to access the data inside the SMS cache. Using the pointer, the application instance can read and write the necessary data to the SMS cache.

Since the SMS cache is shared between application instances of the same application, it is important to save all the data structures required for the management of the cache in the shared memory segment itself. This includes, the entries, key and value, the data structures used by the admission and replacement policies, and other data structures which may be used for the correct management of the shared memory segment.

Thus, with a serverless runtime, mechanisms are provided by the illustrative embodiments for improving the startup time of serverless applications and improving horizontal scaling. In accordance with one or more illustrative embodiments, a cache is built on top of a shared memory segment. The shared memory segment is a portion of memory allocated to an application by the runtime for use by instances of the application such that application instances can communicate data between each other via the shared memory segment when they are otherwise isolated from each other. Each application instance can access and modify the shared memory segment, and mechanisms are provided by the illustrative embodiments to implement a cache in this shared memory segment to thereby provide a shared memory segment-based (SMS) cache (or simply the “cache”). The application instances can use the cache to store any data that may be common amongst the application instances and thus, accessed by the different application instances, such as metadata for business logic, for example. While the illustrative embodiments will use metadata for business logic as an example of the data stored in the cache, the illustrative embodiments are not limited to such. To the contrary, any other type of data that may need to be shared amongst application instances in a serverless runtime computing environment may be shared via the shared memory segment based cache of the illustrative embodiments without departing from the spirit and scope of the present invention.

The cache relies on a serverless runtime capable of providing a pointer to a shared memory segment accessible from different application instances. Assuming the data in the cache is metadata for business logic, since the metadata is needed by each application instance, caching this metadata can improve the memory footprint and the overall throughput of the application instances. The fact that metadata rarely changes means that the application instance workloads are “read heavy” and thus, the use of the cache improves horizontal scaling since reads can be done concurrently. The cache implementation is used by the application instances such that whenever an access is requested on the cache, the data structures saved in the shared memory segment of the cache are used to correctly synchronize and manage the cached data.

### Example Architecture for a SMS Cache

To reiterate, it should be appreciated that the rapid evolution of cloud computing has fundamentally reshaped the landscape of modern information technology (IT) infrastructure and application deployment. Among the various paradigms that have emerged, serverless computing stands out as a revolutionary model that challenges traditional approaches to resource management and scalability. Serverless computing, often referred to as Function-as-a-Service (FaaS), has gained significant traction due to its potential to reduce operational overhead, improve cost efficiency, and accelerate development cycles. By enabling event-driven execution of small, stateless functions, serverless architectures offer an elastic and highly scalable solution that adapts to demand in real-time. This model is particularly attractive for modern applications that experience fluctuating workloads, as it offers a pay-as-you-go pricing model where users only pay for the actual compute resources consumed during execution.

Serverless computing platforms are typically offered by major cloud service providers, each providing a unique set of runtimes that allow developers to run code without worrying about the underlying infrastructure. These runtimes are crucial because they determine the languages and environments in which serverless applications can execute, and they directly impact the performance, scalability, and usability of serverless solutions. An emerging solution to some of the challenges of traditional serverless runtimes is GraalOS available from Oracle Corporation. GraalOS is an application deployment technology that uses GraalVM Native Image to run applications as native machine executables. In the context of serverless computing, GraalOS provides fast startup times, low latency, reduced memory consumption for applications, and other improvements in the context of serverless computing, with high performance even when applications are scheduled on the same process.

In GraalOS each application is run as a thread in a process called a Visor. The Visor is responsible for virtualizing all the operating system resources that are needed by the application. Multiple applications or application instances (each application can have one or more application instances), i.e. threads, can be run concurrently on one Visor, i.e. process. This means that changing between different applications or application instances becomes faster since this equates to changing the running thread. This also means that inter application communication can be done in-memory. The applications, or application instances, cannot make system calls directly to the operating system, but instead must goes through the Visor by making “visorcalls” to the Visor, with the Visor then performing system calls to the operating system as needed. In this way, the Visor isolates the different applications or application instances from each other within the same operating system process. An individual application or application instance, e.g., the code, data, and memory, executing in a Visor process is referred to as an “Isolate” since it is technically isolated from everything and executes as if it was the only application in that operating system process.

GraalVM itself is an advanced Java Development Kit (JDK) with ahead-of-time Native Image compilation. GraalVM accelerates application performance while consuming fewer resources. It achieves this by compiling your Java application ahead of time into a native binary. The native binary is smaller, starts up to 100× faster, provides peak performance with no warmup, and uses less memory and CPU than an application running on a Java Virtual Machine (JVM). The integration with GraalOS improves the startup time and resource usage.

A concrete use case for communication between application instances is the caching of application metadata retrieved from a Database Management System (DBMS). Fast access to this data can improve the startup time and overall performance of the application. Usual approaches to caching are problematic for serverless applications, however. Metadata can be cached locally in each application instance, incurring high memory overhead due to the replication of data. Local caching is also fundamentally incompatible with stateless, short-lived functions.

Before discussing the improvements provided by the illustrative embodiments in greater detail, the following description will first provide an introduction to Micronaut, GraalVM, GraalOS, Oracle DB, and Memory Protection Keys, which will be useful in understanding what these components are, what they offer, how they are used, and later how they connect to each other in the context of one or more example implementations of illustrative embodiments.

### Example Modular Application/Microservices Framework

As noted above, the illustrative embodiments utilize a modular application and/or microservices framework, an example of which is the Micronaut framework. While Micronaut is provided herein as an example, the illustrative embodiments are not limited to such. and other modular application/microservices frameworks can be similarly used to implement aspects of the illustrative embodiments without departing from the spirit and scope of the present invention.

Assuming a Micronaut framework as an example, Micronaut is a full-stack framework designed for building microservices, serverless applications, and applications in resource-constrained environments. It is an alternative to traditional Java frameworks, offering distinct advantages, particularly when it comes to modern cloud-native applications.

Micronaut provides compile-time dependency injection (DI), where dependency injection refers to a software design pattern where a class'dependencies (external objects it needs to function) are passed in as arguments to its constructor, method, or set by a configuration file, rather than being created within the class itself. Unlike traditional frameworks which rely heavily on runtime reflection for dependency injection, Micronaut leverages compile-time dependency injection. This approach eliminates the need for reflection, resulting in a significant reduction in runtime overhead. By resolving dependencies at compile time, Micronaut ensures that applications are lightweight, faster, and more efficient. This is especially important in microservice architectures, where resources and performance are critical.

Micronaut provides a small memory footprint and low latency. Micronaut is designed to minimize the memory consumption of applications and provide high performance. This is achieved by optimizing the framework's internals and minimizing unnecessary resource usage. Micronaut's architecture ensures that it works well in environments with limited resources, such as cloud computing environments or serverless platforms. Its low memory footprint and fast startup times make it a strong contender for serverless applications, where cold start times are a critical factor.

Micronaut supports GraalVM and native image compilation. That is, a compelling feature of Micronaut is its compatibility with GraalVM, which allows developers to compile Micronaut applications into native executables using GraalVM's native-image tool. This enables significant reductions in startup time and memory usage. This makes Micronaut applications even more suitable for cloud computing runtimes and serverless environments. The integration with GraalVM allows Micronaut applications to run with near-instant startup times, making them ideal for highly dynamic environments like serverless platforms.

Micronaut provides built-in caching support for applications, making it easy to cache data at the method or class level. This allows developers to easily store and retrieve frequently accessed data, thereby improving the performance of their applications by reducing the need for repeated data retrieval or computation. Caching can be used to store results of method calls, database queries, or API responses. Micronaut's caching mechanism is highly configurable and can be customized based on application needs. Micronaut allows users to provide their own custom cache implementations, enabling greater flexibility for developers. If the default caching solutions do not meet the specific needs of an application, users can integrate custom caching mechanisms by implementing the cache interface. This custom cache implementation can then be used in the same way as any built-in cache, providing developers with full control over cache behavior, eviction policies, and storage mechanisms. This feature allows applications to utilize tailored caching solutions optimized for their unique requirements.

While Micronaut provides custom cache implementations, these implementations are siloed on an application instance by application instance basis. That is, each application instance has its own corresponding cache. There is no capability to share cached data between application instances. As described hereafter, the illustrative embodiments provide mechanisms for facilitating shared memory segment-based (SMS) cache mechanisms such that application instances may share cached data between the application instances and thereby improve the overall performance of the application instances as a whole.

### GraalVM

As noted above, GraalVM is an advanced Java Development Kit (JDK) with ahead-of-time native image compilation, designed to run applications written in multiple programming languages. GraalVM supports a wide variety of languages, including Java, JavaScript, Ruby, R, Python, and WebAssembly. This polyglot nature makes GraalVM a powerful tool for developers working in multi-language environments, as it allows for interoperability between languages and seamless execution within the same runtime.

GraalVM features a just-in-time (JIT) compiler called Graal, which is designed to produce highly optimized machine code, resulting in improved execution performance. GraalVM enhances the speed and efficiency of applications, particularly those that require heavy computational workloads. GraalVM introduces the native-image functionality, which enables developers to compile Java applications (and applications in other programming languages) into native executables. These native executables start up faster and consume less memory compared to traditional JVM-based applications, making them an ideal choice for cloud-native and serverless applications.

GraalVM allows for seamless interaction between different programming languages within the same runtime environment. For example, a Java application can directly invoke C code without the need for external bridges or complex integrations. This polyglot feature makes it easier for developers to combine tools and libraries from various programming ecosystems while benefiting from the optimizations of a single runtime.

GraalVM provides enhanced profiling and debugging capabilities that allow developers to optimize their applications more effectively. With support for advanced profiling tools and a more detailed view of the program's execution, developers can identify performance bottlenecks and optimize their applications accordingly. In addition, GraalVM also allows native images to include C/C++libraries. These libraries can be used in the Java application as if they were Java functions.

### GraalOS

GraalOS is a high-performance serverless application deployment platform, or serverless runtime. GraalOS fully integrates GraalVM's polyglot capabilities, allowing developers to write, execute, and interoperate code in multiple programming languages, such as Java, JavaScript, Python, Ruby, R, and C/C++. This feature promotes language-agnostic development, enabling teams to use the best-suited language for each component of their applications.

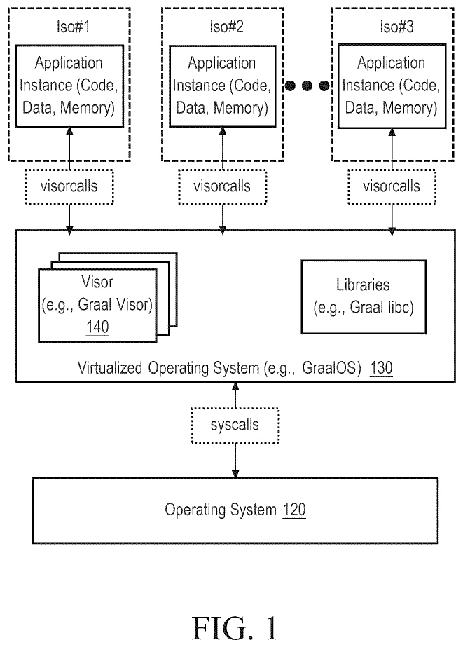

FIG. 1 is an example block diagram illustrating an example GraalOS configuration in accordance with one illustrative embodiment. As shown in FIG. 1, GraalOS runs different applications, i.e. untrusted native code (ELF binary), e.g., Java (GraalVM Native Image), as “Isolates”, e.g., Iso #1, Iso #2, and Iso #3 110-114. These Isolates 110-114 are independent from each other, which means that from their point of view, they have access to all the resources the operating system (OS) 120 provides. Isolates access these resources using system calls (syscalls). GraalOS 130 introduces an in-process security boundary that separates the privileged (and trusted) “Visor” 140 from the unprivileged (and untrusted) “Isolates” 110-114. From the point of view of Isolates 110-114, they are running as processes on top of an OS kernel of the OS 120. All Isolate 110-114 code is untrusted and thus, while there are no restrictions in place that prevent Isolate code from modifying or corrupting its own state, it may not compromise the confidentiality, integrity and availability of the trusted Visor 140. The Visor 140 executes in user-mode within the same operating system process as the Isolate 110-114 the Visor 140 manages (each Visor 140 may handle multiple applications or application instances in the same process, or there may be a separate Visor for different applications). Isolation between the Isolates 110-114 and the Visor 140 is achieved using both software and hardware mechanisms.

In contrast to running the Isolate 110-114 as a regular process on the host OS 120, running an Isolate 110-114 on GraalOS 130 provides stronger protection through the additional security boundary introduced by GraalOS 130. An Isolate 110-114 cannot directly invoke system calls, and instead invocations are managed by the Visor 140, such as via “visorcalls” between the application instances, or Isolates, 110-114 and the Visor 140. Further, an Isolate's instruction stream is significantly limited, i.e., compared to a regular user-mode process, an Isolate 110-114 has to conform to specific patterns for control flow transfers and cannot contain numerous potentially security-critical instructions. The user-supplied Isolate binary executable code of the user application is first verified by Binsweep, which is a tool that examines code and checks whether it conforms to GraalOS's policies. Isolates 110-114 are built with a custom toolchain including modified compilers that only emit GraalOS 130 policy conforming code.

Upon successful examination, the Visor 140 loads the Isolate 110-114 code into the Visor's address space. The result of loading an Isolate 110-114 is an active instance of this Isolate 110-114. The Visor 140 can now execute the Isolate's entry point. The Visor 140 supports executing multiple instances of the same Isolate, i.e., multiple application instances of the same application, e.g., each of the Isolates 110-114 may be separate instances of the same application. To perform privileged operations, the Isolate 110-114 invokes the Visor's system call virtualization, i.e., the visor syscall, or “visorcall”. This means that whenever an Isolate 110-114 does an allowed syscall, the syscall is intercepted by the Visor 140.

Visorcalls are syscalls intercepted by GraalOS 130. A visorcall can either use the default implementation provided by some library, e.g. libc, or a custom implementation. It is also possible to provide custom visorcalls to the client process, or user, which can be used to give access to different features backed by GraalOS 130, or the Oracle Database (DB) in the case of GraalOS-In-DB.

### Oracle Database

Oracle Database (DB) is a highly scalable and flexible relational database management system (DBMS) widely used in enterprise environments. It is designed to efficiently store, retrieve, and manage large volumes of structured and unstructured data while supporting a wide range of applications and workloads. Since its inception in the late 1970s, Oracle Database has continually evolved, offering robust features that cater to enterprise-grade requirements for performance, scalability, and security.

### DBMS Overview

The mechanisms of the illustrative embodiments may be implemented to improve the performance of application instances by providing a shared memory segment-based cache for sharing data between application instances in a serverless runtime environment. These application instances, in some illustrative embodiments, may operate in conjunction with database and corresponding database management system, such as with regard to database queries executed by the application instances via the serverless runtime. The following is a description of a database system and its components with which such vector indexing technologies may be employed and with which the mechanisms of the illustrative embodiments may be implemented to improve upon these vector indexing technologies.

A database management system (DBMS) manages a database, with a relational DBMS (or RDBMS) managing a relational database, such as Oracle DB. A DBMS may comprise one or more database servers. A database comprises database data and a database dictionary that is stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

A database command may also be in the form of an API call. The call may include arguments that each specifies a respective parameter of the database command. The parameter may specify an operation, condition, and target that may be specified in a database statement. A parameter may specify, for example, a column, field, or attribute to project, group, aggregate, or define in a database object.

In a DOCS, a database command may be in the form of functions or object method calls that invoke CRUD (Create Read Update Delete) operations. Create, update, and delete operations are analogous to insert, update, and delete operations in DBMSs that support SQL. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

When operations are referred to herein as being performed at commit time or as being commit time operations, the operations are performed in response to a request to commit a database transaction. DML commands may be auto-committed, that is, are committed in a database session without receiving another command that explicitly requests to begin and/or commit a database transaction. For DML commands that are auto-committed, the request to execute the DML command is also a request to commit the changes made for the DML command.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, a branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables and other information.

A database server includes multiple database processes. Database processes run under the control of the database server (i.e. can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g. shared access to a set of disk drives and data blocks stored thereon. The nodes in a multi-node database system may be in the form of a group of computers (e.g. workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains definition metadata that defines properties of the database object. For example, definition metadata in a database dictionary defining a database table may specify the attribute names and data types of the attributes, and one or more files or portions thereof that store data for the table. Definition metadata in the database dictionary defining a procedure may specify a name of the procedure, the procedure's arguments, and the return data type, and the data types of the arguments and may include source code and a compiled version thereof.

A database dictionary is referred to by a DBMS to determine how to execute database commands submitted to a DBMS. Database commands can access or execute the database objects that are defined by the dictionary. Such database objects may be referred to herein as first-class citizens of the database. A first-class citizen is associated with a database object name, which can be referenced in database commands to identify the first-class citizen to DBMS. The database object name is mapped or otherwise associated with the database object. The DBMS refers to the definition metadata of the first-class citizen to determine how to access or execute the first-class citizen.

A database object may be defined by the database dictionary, but the definition metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e. java file) and the compiled version of the class (i.e. class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as a valid data type and to be processed by a DBMS in database statements. In general, database software of a DBMS is programmed to recognize and process native data types without configuring the DBMS to do so by, for example, defining a data type by issuing DDL statements to the DBMS.

### Managed Global Area (MGA)

In accordance with one or more of the illustrative embodiments, the database architecture, such as the Oracle DB architecture, includes a Managed Global Area (MGA) component, which is a memory structure that allows different processes to share memory segments and thus, allows inter-process communications. As described in greater detail hereafter, in one or more illustrative embodiments, the MGA component is adapted to provide a shared memory used by the application instances to provide a shared memory-based (SMS) cache between application instances.

The MGA is a dynamic elastic shared memory which is used for a subset of processes. This means that different processes can use MGA to efficiently communicate between them. MGA can be created post instance startup, dynamically grown or shrink when there is no need of the memory anymore. In the Oracle DB the MGA component has a number of uses, for example for shared Public Domains (PDs) and for Structured Query Language (SQL) execution. The provided API of the DBMS allows processes to initialize MGA memory segments, attach themselves to the segment, change the properties of the segment or tear down the segment.

### Memory Protection Keys

Memory Protection Keys (MPKs) are a hardware-assisted mechanism designed to provide finer-grained access control over memory pages without requiring modifications to page tables. MPKs enable efficient runtime memory protection adjustments. MPKs operate by associating each memory page with a protection key, e.g., a 4-bit protection key, stored in the page table entry (PTE). The processor maintains a separate register, referred to as the Protection Key Rights Register (PKRU), which contains access permissions for a predetermined number of protection keys, e.g., up to 16 protection keys. This allows software to change access rights dynamically without incurring the overhead of modifying page tables and triggering Translation Lookaside Buffer (TLB) flushes.

All the threads of the same process share the same mapping Memory Page→Key, but each thread can have different access rights for different pages. Key operations involved in MPKs include assigning protection keys to memory pages via page table entries, modifying access permissions using the WRPKRU instruction (which updates the PKRU register without requiring privileged execution), and enforcing access rights, where unauthorized access to a protected page results in a page fault.

MPKs have several practical applications, particularly in security and performance optimization. For example, MPKs can be used for security hardening in that MPKs help mitigate vulnerabilities such as memory corruption and unauthorized memory accesses by enforcing strict access policies at runtime. MPKs provide efficient isolation in that software components, such as sandboxed execution environments, can use MPKs to isolate different memory regions with minimal performance overhead. MPKs provide performance optimization by providing an efficient way to manage memory permissions dynamically, thereby avoiding frequent TLB flushes and reducing system call overhead. MPKs provide software fault isolation (SFI) in that MPKs can be leveraged to compartmentalize applications, preventing unintended interactions between software components. Overall, MPKs offer a flexible and efficient mechanism for memory access control, enhancing both security and performance in modern computing systems.

### Shared Memory Segment-Based Cache Design

With the above description as a basis, the illustrative embodiments provide mechanisms for implementing a shared memory segment-based cache in the context of serverless applications. One concrete use is the caching of application metadata retrieved from a DBMS, which is a common bottleneck in enterprise applications that need substantial metadata for business logic validation. While this will be used as an example use case for illustrating the improvements provided by the improved computing tool and improved computing tool operations/functionality of the illustrative embodiments, it should be appreciated that the illustrative embodiments are not limited to this particular use case and the mechanisms of the illustrative embodiments may be implemented for caching any data that is to be shared amongst application instances of a same application via a shared memory segment-based cache according to the present invention.

Existing approaches to caching are problematic for serverless applications. Metadata can be cached locally in each application instance, incurring high memory overhead due to the replication of data in each application instance. Local caching is also fundamentally incompatible with stateless, short-lived functions. The common alternative of a shared cache, however, incurs network overhead for data access and object serialization and deserialization.

The illustrative embodiments provide a caching solution that is optimal for the scenario of multiple application instances executing in a serverless runtime, and are especially optimal with regard to application instances that are co-located on the same node or host computing device. Concretely, a goal of the illustrative embodiments is to implement a shared-memory multi-process cache that is accessible to mutually trusting but isolated application instances (Isolates). The illustrative embodiments, achieving such a goal, improve start-up time and horizontal scaling. The underlying shared memory is provided by the host's serverless runtime, e.g., a GraalOS runtime, which is modified according to the mechanisms of the illustrative embodiments for allocating and deallocating a shared memory segment for use as a shared cache between application instances, and to provide the communication mechanism between the runtime and application instances, giving access to the application instances and returning pointers to the shared memory segment which holds the shared memory segment-based cache.

In some illustrative embodiments, the serverless runtime is fused into a DBMS. For its developer-facing API, in some illustrative embodiments, the shared memory segment-based cache is integrated into modular application frameworks, such as the Micronaut framework, for example. Access to shared memory is mediated through MPKs, with a key management scheme that makes efficient use of the limited resource of protection keys.

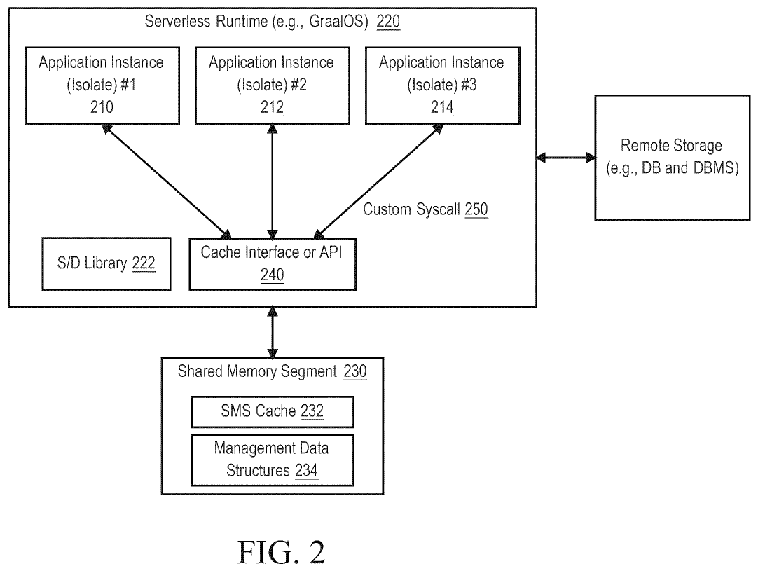

FIG. 2 is an example block diagram illustrating an overall system design for a shared memory segment-based cache in accordance with one illustrative embodiment. As shown in FIG. 2, each application instance 210-214 is run on the serverless runtime 220. The serverless runtime 220 is responsible for providing a communication mechanism between application instances 210-214 and itself, as well as allocating and deallocating memory segments, e.g., shared memory segment 230, accessible from different application instances, and giving access, to the shared memory segment 230, to application instances 210-214. The application instances 210-214 are instances of a same application, e.g., Isolates of the same application. It should be appreciated that different shared memory segments 230 may be allocated to different sets of application instances 210-214 of different applications, such that application instances of a first application will have access to a first shared memory segment and application instances of a second application will have access to a different second shared memory segment.

An important capability of the mechanisms of the illustrative embodiments is communication between the serverless runtime 220 and the application instances 210-214. The serverless runtime 220 provides mechanisms to receive requests from the application instances 210-214 and return back corresponding data. In accordance with one or more illustrative embodiments, this communication is achieved by the serverless runtime 220, which for illustration purposes is considered to be GraalOS, with custom syscalls to a Visor, also referred to as visorcalls. In such illustrative embodiments, GraalOS as the serverless runtime 220 intercepts syscalls and uses an internal implementation for each one, where this internal implementation refers to the internal definition of the Visor mechanism for virtualizing system calls (syscalls). GraalOS provides a way to add custom syscalls, which allows for exposure of internal features of the serverless runtime 220 to the application instances 210-214, such as the information regarding the shared memory segment 230 in accordance with the illustrative embodiments.

The illustrative embodiments provide a custom syscall 250 that is used by the application instances 210-214 to request a pointer to the shared memory segment 230. In response to this custom syscall 250, the application instance 210-214 receives back, from the serverless runtime 220, a variable of type long that is a pointer to the shared memory segment 230.

A second important capability of the serverless runtime 220 is the allocation and deallocation of the shared memory segment 230. The serverless runtime 220 is able to allocate and deallocate an amount of memory usable by the application instances 210-214 and then is able to “attach” each application instance 210-214 to this memory, e.g., shared memory segment 230. This “attaching” means that the serverless runtime 230 performs operations to give access to the application instances 210-214 to access the shared memory segment 230 such that they can access, read from it, and write to it.

The shared memory segment 230 is provided by the serverless runtime 220, however the way the shared memory segment 230 is used is up to the application instances 210-214. This configuration provides security properties because it is not necessary to manage an untrusted cache, and instead the application instances 210-214 are able to perform such management of a trusted cache in the form of the shared memory segment 230 providing a caching capability.

The shared memory segment-based cache provided via the shared memory segment 230 can be used in any application instance 210-214 by using a corresponding cache interface, or cache API, 240. The cache interface, or API, 240 provides three primary functions: PUT(key, value), GET(key), and INVALIDATE(key). The PUT(key, value) function caches the value using the provided key. The GET(key) function returns the value cached with the specified key if it exists. The INVALIDATE(key) function removes the entry with the specified key from the cache if it exists.

The API can be used by the application instances 210-214 for the caching of desired data in the shared memory segment-based cache, or SMS cache 232, provided in the shared memory segment 230. For example in the case of Java, the data passed to the SMS cache is a Java Object. Many programming languages manage data through objects (e.g., Java, C++, Python, etc.) and, since the illustrative embodiments endeavor to cache data in the SMS cache 232 for shared use by the application instances 210-214, the illustrative embodiments provide a way to serialize and deserialize the objects when it is requested by an application instance 210-214 from the SMS cache 232. In some illustrative embodiments, a serialization/deserialization (S/D) library 222 is provided that can be used to serialize the object as a string in JSON, or any other desired format, when caching in the SMS cache 232, and then back to an object when retrieved from the SMS cache 232.

Depending on the system in which the illustrative embodiments are implemented, more performant solutions are usable. For example, in some illustrative embodiments, the solution may copy-in the raw representation of the object as-is into the SMS cache 232 during a PUT request. Since the cached data is going to be used by different application instances 210-214 of the same application, it is not necessary to encode it in a format like JSON. Creating a copy of the object tree as is can significantly improve the performance but requires a more tight integration with the serverless runtime 220 and is very depend on the underlying system. Thus, the most portable solution is with a S/D library 222 implementation.

Thus, application instances 210-214, such as web application instances, use the SMS cache 232 via an interface or API 240 to cache and request data in the shared memory segment 230. The SMS cache mechanisms of the serverless runtime 220 handle the serialization and deserialization of the object. The application instance 210-214 requests access to the shared memory segment 230 from the serverless runtime 220, which is able to allocate and deallocate such shared memory segments to applications, and thus the application instances 210-214. The serverless runtime 220, which provides the communication mechanism, gives access to the application instances 210-214 and returns, to the application instances 210-214, the pointer to such memory segment 230. The pointer is used by the application instances 210-214 to access the data inside the SMS cache 232. Using the pointer, the application instances 210-214 can read and write the necessary data from/to the SMS cache 232.

Since the SMS cache 232 is shared between application instances 210-214, all the data structures required for the management of the SMS cache 232 are stored in the shared memory segment 230 itself. This includes, the entries, key and value, the data structures used by the admission and replacement policies and other data structures which may be used for the correct management of the shared memory segment 230. These are collectively referred to herein as the management data structures 234.

The solution provided by the illustrative embodiments, in providing a communication mechanism via a serverless runtime environment 220 between the serverless runtime and application instances 210-214, mechanisms for allocating a shared memory segment 230 to applications, communicating pointers to shared memory segments 230 to application instances 210-214, and interface elements 240 for utilizing the shared memory segment 230 to implement a SMS cache 232 for application instances 210-214, avoids data duplications over multiple application instances 210-214, as is the case for in-process cache solutions where each application instance 210-214 has to create and manage its own siloed cache that is not accessible by other application instances 210-214. As a result, memory consumption is reduced considerable when scaling over the number of application instances 210-214.

### Example Micronaut Based Implementation

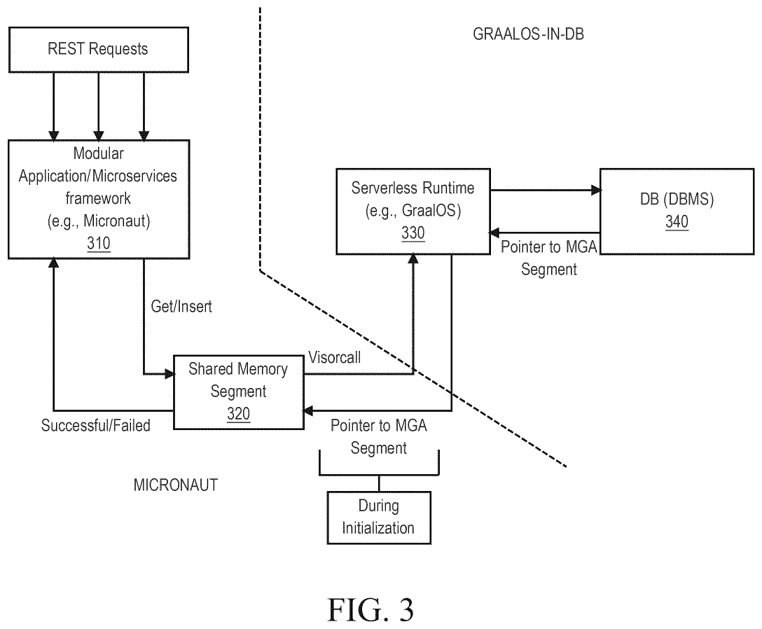

FIG. 3 is an example block diagram of a modular application/microservices framework based architecture in accordance with one illustrative embodiment. In the example shown in FIG. 3, the modular application/microservices framework 310 is implemented using the Micronaut framework as an example implementation. As shown in FIG. 3, the modular application/microservices framework 310, e.g., the Micronaut framework 310, handles the incoming client requests for accessing resources, e.g., REST requests, where these client requests may be from application instances, such as application instances 210-214 in FIG. 2. The SMS cache uses the shared memory segment 320 to cache the data. The serverless runtime 330, e.g., GraalOS, provides isolation to the application instances with respect to other application instances and functions as a bridge between the application instances and the backend database 340, e.g., an Oracle DB and corresponding RDBMS, through a visorcall mechanism. The DB 340 provides a shared memory segment 320, such as the MGA segment, which allows the sharing of data between different isolated application instances, or “Isolates”.

For the depicted implementation a web framework Micronaut implementation is utilized. While it not necessary to use a web framework, web frameworks simplify the creation of application instances for the web. Micronaut also allows the usage of a custom cache through the use of annotations. By default, Micronaut uses Caffeine as its caching implementation, while also supporting other backends such as Ehcache, Hazelcast, and Redis, among others.

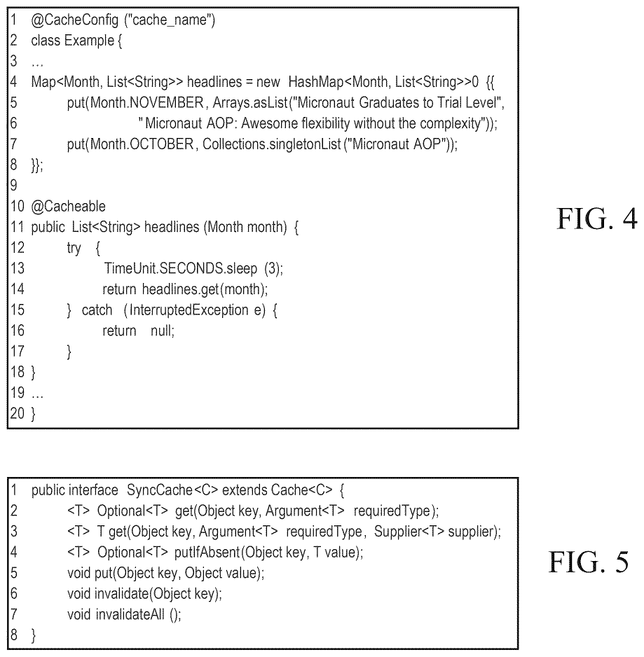

Users can customize which results to cache based on the specific needs of their applications. The code snippet in FIG. 4 demonstrates an example illustrating the caching capabilities of Micronaut. Micronaut allows the creation of multiple cache instances, enabling different parts of an application to utilize distinct caches. For example, one cache could store user inputs, while another cache can be used to cache database query results. Each cache is uniquely identified by a name, and the annotation @CacheConfig(“name”) is used to indicate that a class will use the cache instance identified by the specified name. If the specified cache instance does not already exist, Micronaut invokes the getCache(String name) method in the CacheManager. This, in turn, constructs the necessary cache instance. The annotation @Cacheable designates that the return value of a method will be cached, with the cache key generated from one or more of the method's parameters.

When the headlines method is invoked, Micronaut first calls the get method of the cache's API. If the get method returns null, it indicates that no cached result exists for the given key, prompting Micronaut to execute the headlines method and cache its result. Otherwise, the cached result is returned. This annotation-based approach simplifies cache integration within the application. Micronaut also allows client processes to implement custom caching mechanisms by defining two key interfaces: CacheManager which is responsible for creating and managing cache instances, and SyncCache which defines the core cache API, an example of which is shown in FIG. 5. These methods are implemented when creating a custom cache. For example, the get and put methods accept generic Java objects as input and store these in the cache's internal memory format. Depending on the implementation, this memory can either reside on the Java heap or off-heap memory. The cache may store references to the objects (pointers into the Java heap) or serialize the objects into a specific internal format, requiring serialization and deserialization processes.

The CacheManager interface is responsible for the creation of a cache instance. The CacheManager interface mandates the implementation of the getCache(String name) method, which creates a cache instance. This instance is returned to Micronaut and is subsequently used whenever the cache is accessed via annotations.

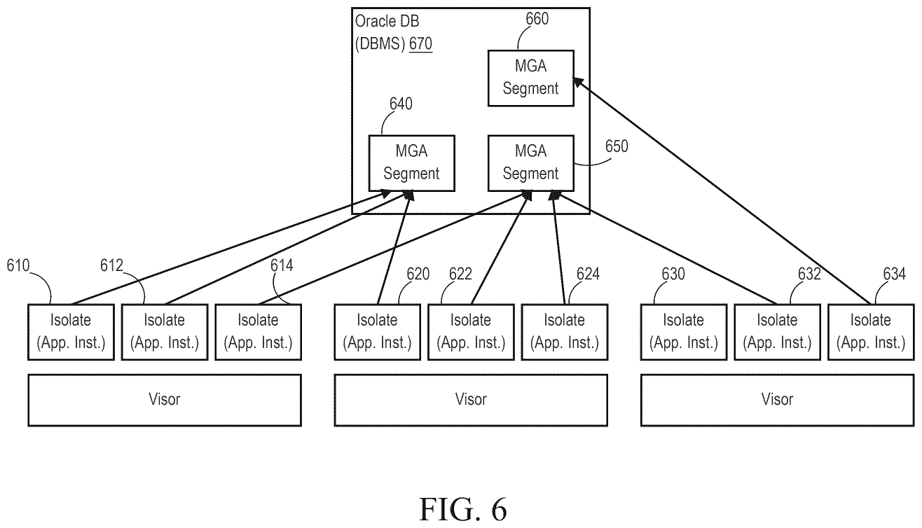

In some illustrative embodiments, and in the example shown in FIG. 3, the serverless runtime 330 is implemented using GraalOS available from Oracle Corporation. FIG. 6 shows an example overview of a GraalOS-In-DB configuration in accordance with one illustrative embodiment. By GraalOS-In-DB, what is referred to is the integration of the GraalOS runtime, e.g., runtime 330, into a DBMS, such as the Oracle DB's DBMS (or RDBMS). This integration eliminates network overhead for data access, enabling data-centric user applications to operate with greater efficiency.

GraalOS assures isolation between application instances and, due to the mechanism of visorcalls, the application instances have access to the DBMS and to the internals of the GraalOS runtime. A visorcall acts as a specialized system call intercepted by GraalOS, which executes an internal implementation. Standard syscalls can be handled using a library, such as libc. For custom syscalls, however, an implementation is provided which can expose features of GraalOS or the DBMS to the application instances.

In accordance with one or more of the illustrative embodiments, the modular application/microservices framework 310, e.g., Micronaut framework, leverages a custom cache, which, upon initialization, obtains a shared memory segment 320 from the serverless runtime 330, e.g., GraalOS. This process is achieved through a custom syscall whose implementation calls the interface or API of the DMBS of the DB to request the shared memory segment.

When a segment is requested, the DBMS first checks whether the segment has already been initialized. If it has not, the DBMS initializes the segment, attaches, i.e. adds the requesting process, e.g., application instance, to the list of processes which can access the shared memory, and returns a pointer pointing to the shared memory segment, back to the requesting process. The shared memory segment is then used by the requesting process to store data as part of an SMS cache and thereby efficiently store and manage cached data.

In FIG. 6 it can be seen that each Isolate 610-614, 620-624, and 630-634 (application instances) can access their corresponding shared memory segments 640, 650, or 660 after having requested it. Since the shared memory segments are created and allocated by the DBMS of the DB 670, the shared memory segments are off the Java heap. It is the SMS cache's responsibility to move or copy the Java object from the Java heap to the shared memory segments 640-660. The size of the shared memory segments 640-660 are fixed. This means that when created, the shared memory segments 640-660 cannot have their size increased or decreased.

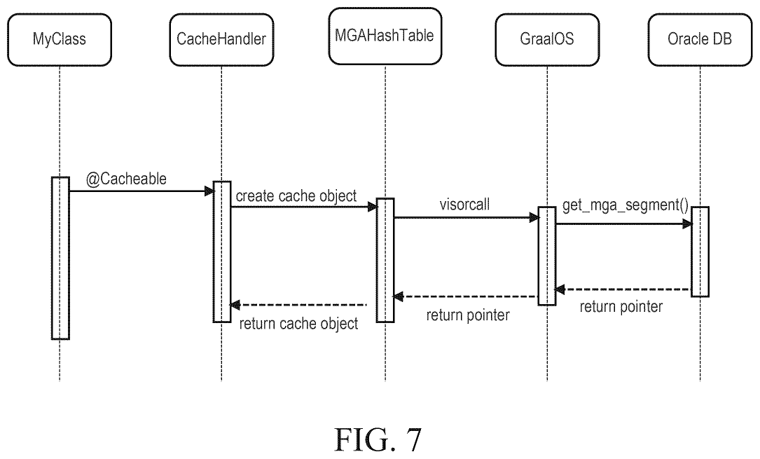

FIG. 7 shows an example process for initialization of a shared memory segment based cache in accordance with one illustrative embodiment. As shown in FIG. 7, when an application instance specifies that certain data is cacheable, e.g., by using the example of the @Cachable annotation in Micronaut, for example, the cache handler automatically handles the creation of the cache object if it has not been already initialized. The constructor of the cache initializes internal fields and does a visorcall which is intercepted by GraalOS. The implementation of the visorcalls then calls the get_mga_segment function which calls the API of the DBMS of the Oracle DB in this example, attaches the process to the mga segment, and then returns the pointer to this mga segment. The pointer is used internally by the SMS cache to store the objects.

For ease of implementation, in accordance with one or more of the illustrative embodiments, the SMS cache is implemented using both Java and C programming languages. The C programming language was chosen because it offers low-level memory manipulation capabilities and easier use of synchronization primitives. Additionally, the C programming language's lightweight runtime and close-to-the-metal performance ensures that the cache operations remain fast and responsive. By combining C for the core cache logic, and Java for the higher-level API, the illustrative embodiments can leverage the strengths of both languages: C for performance-critical operations, and Java for its robust ecosystem and ease of integration. The implementation in Java is responsible for the serialization of the Java object, while the implementation in C is responsive for the management of the SMS cache. The API of the SyncCache takes, as an input, a Java object, while the API of the implementation in C takes, as an input, a pointer to a location in the Java heap where the serialized object lies. This hybrid approach allows the illustrative embodiments to maintain flexibility while achieving optimal performance and developer productivity.

### SMS Cache

When building the shared memory segment-based (SMS) cache, it is important to understand the type of workloads the SMS cache will need to handle. Again, an example use case is the caching of application metadata required for business logic. Since metadata rarely changes, the workload is read-heavy with a large number of accesses. The number of concurrent users is high since each application needs to handle multiple REST requests and each of them accesses the metadata. Thus, with this type of workload, the SMS cache needs to handle read-heavy workloads, handle multiple concurrent users, and have acceptable performance.

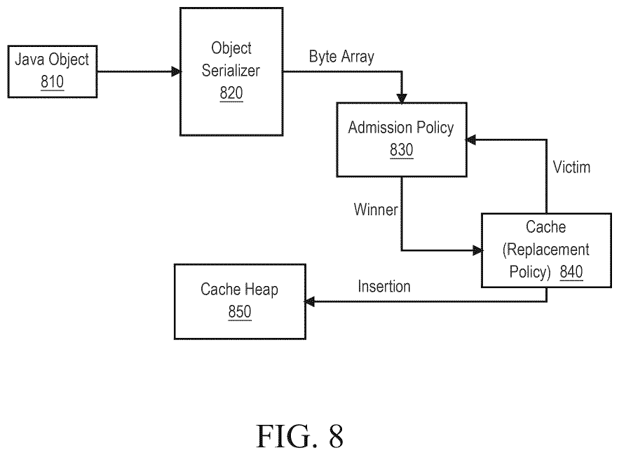

FIG. 8 shows an example block diagram of an overall architecture of the SMS cache in accordance with one illustrative embodiment. As noted previously, in accordance with one or more of the illustrative embodiments, the get and put functions take Java objects 810 as inputs. Since the objects are to be stored in the shared memory segment which implements the SMS cache, the Java objects are serialized via the object serializer 820 when stored to the SMS cache, and deserialized back into Java objects 810 when requested from the SMS cache. Such serialization/deserialization is necessary since, in general, serverless runtimes do not provide mechanism to move runtime objects between different application instances. This means that the serialized object is stored in the SMS cache and deserialized back into an object 810 when requested from another application instance of the same application.

Another operation performed by the SMS cache is to check if there is a free space for a new entry in the SMS cache. If there is free space for the new entry, the new entry is inserted. If there is not free space for the new entry, a replacement policy 840 is responsible for determining which existing entry to eject to make room for the new entry. The admission policy 830 decides whether to accept the incoming entry (new entry) with respect to the victim entry (the entry chosen for ejection). If the incoming entry is inserted into the SMS cache, the entry is written in the cache heap 850 section. Since one of the requirements is the support for variable-length objects, this support is achieved by having a part of the shared memory segment behave like a heap 850. This area has its own data structures which allow for the allocation and deallocation of memory blocks. More specifically there is a malloc(size) and a free(block) function for this part of the shared memory segment.

As noted above, GraalOS provides a Managed Global Area (MGA) which can be used to provide the shared memory segment for implementation of the shared memory segment-based cache of the illustrative embodiments. With GraalOS and GraalVM, a MGAHashTable class implements a SyncAPI interface, providing the required API functionality for implementing the mechanisms of FIG. 8. The MGAHTWrapper class acts as a bridge between the Java application and the native C code, enabling seamless communication. On the C side,, the mgahashtable. c library module handles operations such as reading, writing, and managing segments, while memory. c is responsible for managing the cache heap.

The MGAHashTable class is responsibilities for correctly implementing the API defined in the SyncAPI interface, invoking the API methods provided by the MGAHTWrapper, and passing pointers to serialized Java objects to the MGAHTWrapper for further processing. The MGAHTWrapper exposes the C function as Java function which can be called from the MGAHashTable class. The mgahashtable.c module handles the insertion of the entries in the cache, the synchronization of the operations for concurrent requests, and the data structures used by the admission policies 830 and replacement policies 840.

The memory. c module handles the allocation of blocks in the head area of the cache, the synchronization of the operations for concurrent requests, and the data structures used by the admission policies 830 and replacement policies 840. The memory module has an API comprising malloc block(int size) which returns a pointer to a block where at most “size” bytes of data may be written, and free block(char↓ptr) which frees the block and makes it usable for another entry.

One aspect of this example implementation, in accordance with some illustrative embodiments, is the separation of synchronization responsibilities between the Java side and the C side. Synchronization of the serializer and deserializer on the Java side is independent of the synchronization required for the cache on the C side. When multiple REST requests are received, the Micronaut framework processes them. Since serialization and deserialization (S/D) can occur concurrently, no synchronization mechanisms are needed on the Java side. However, when the API of the C side is invoked, via the wrapper over the C functions, the data structures stored in the shared memory segment ensure proper synchronization of the cache between multiple threads and processes.

### Example Initial Version of SMS Cache

In an example initial version of the SMS cache, in accordance with one illustrative embodiment, the SMS cache has the following design: a Serialization/Deserialization (S/D) of Java Objects in JSON, an admission policy that accepts all incoming entries, a replacement policy that selects at random an entry to eject, a synchronization that is done through a global lock on the entire cache, and a maximum size for saving blocks, with a fixed size block allocation for the heap area of the cache.

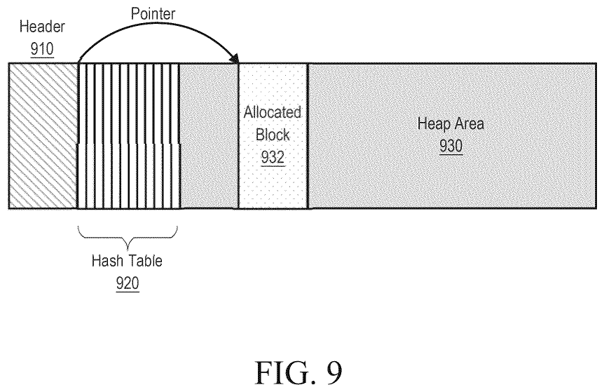

FIG. 9 shows an example of an initial design structure for a shared memory segment (SMS) that can be used to provide the SMS cache in accordance with one illustrative embodiment. As shown in FIG. 9, the shared memory segment 900 is divided into three sections or areas, i.e., the segment header 910, the hash table 920, and the heap area 930 where the allocated block 932 is located.

In one illustrative embodiment, the segment header 910 is 12 bytes long, although other embodiments may utilize different sizes of segment headers 910 without departing from the spirit and scope of the present invention. In this illustrative embodiment, the first 4 bytes are interpreted as an unit to indicate the size of the segment in bytes. With 4 unsigned bytes this illustrative embodiment can have a segment up to 4GB. The second 4 bytes of the segment header 910 is interpreted as an int, and are used for the initialization of the cache. The state can be uninitialized or initialized. if the state is uninitialized, this means that this is the first time the segment is used by an Isolate (isolated application instance) and as such, the data structures of the shared memory segment will need to be initialized. Since the state of the cache will be shared between all Isolates, all relevant data structures need to be kept in the shared memory segment itself. If the state is INITIALIZED, then the segment can be used as is, without having to perform any initialization of the data structures to perform operations. The final 4 bytes are interpreted as an int, and are used for the Compare-and-Swap (CAS) operation (an atomic operation that compares a memory location's value with an expected value for updating the memory location with a new value) and as a lock for the cache.

The hash table 920 is an array-like structure where each entry is of a predetermined size, e.g., a size of 4 bytes or the like. The value stored in a cell indicates the offset of an allocated block in the heap area 930, where the actual data, e.g., allocated block 932, of the entry is stored, from the start address of the heap area 930. Two special values are used to indicate the state of the cell when not used by an entry: 0×0—EMPTY to indicate that the cell is empty, and 0×1—TOMBSTONE to indicate that the cell has a tombstone, i.e., an indicator that the block is free and can be overwritten with other data. The values 0 and 1 can be used to indicate the state of the cell because it is impossible to have an object start at offset 0 or 1 in the heap area 930. The total number of entries in the hash table 920 is fixed, with an example of the total number of entries being 1024 total entries, although other numbers of entries may be used in various embodiments without departing from the spirit and scope of the present invention. When the cache is used for the first time, all the entries in the hash table 920 are initialized to 0×0.

The heap area 930 is the section of the shared memory segment 900 where the serialized Java objects are stored along with other information used to handle the entry in the hash table 920. For this example embodiment of the SMS cache, each time there is a call to malloc(size) from the memory module, i.e., the code responsible for managing the memory in the cache (e.g., allocating new objects or freeing unused memory), an offset is returned from the beginning of the heap area 930 for the allocated block, e.g., allocated block 932. The maximum amount of data in the allocated block is fixed, and there is a check on the amount of data that is being written since an overlap with the next block will cause corruption of the entry.

Synchronization may be performed using serial synchronization, meaning that each operation is done only after the previous one has completed. In this case each operation is atomic. In this initial version of the SMS cache, the synchronization is global on the entire SMS cache and it is achieved using a global lock. Each time an operation is to be performed, e.g., PUT, GET, or INVALIDATE, a lock on the SMS cache is obtained and it is unlocked after the operation has completed.

Since the cache is managed by different Isolates, the lock mechanism is saved in the SMS cache itself. The mechanism used for the synchronization is a CAS operation, which again is an atomic operation and is used in concurrent programming to achieve synchronization. It operates on a memory location and takes three arguments: the memory location, an expected value, and a new value. The CAS operation works by comparing the current value at the memory location with the expected value and, if they match, the memory location is updated with the new value. This entire operation is performed atomically, ensuring that no other thread can modify the memory location during the comparison and update process. If the current value does not match the expected value, the operation fails, and no changes are made.

The illustrative embodiments use two values to indicate if the SMS cache is locked or not, e.g., 0×0 to indicate that the cache is not locked, and 0×1 to indicate that the cache is locked. The value 0×2 is used to indicate that the lock has been used once and cannot be reused. This is used only in the initialization phase since it is only necessary to initialize the data structures once before they can be used.

The SMS cache can be thought of as being in different states. After it has been created it is in the state: NOT INITIALIZED with the second 4 bytes equal to 0×0. An attempt is made to then change the state to INITALIZING by atomically changing the value to 0×1. If this fails, it means that some other Isolate has already started the initialization, at which point the thread/process waits until this initialization is finished. This is done by periodically checking the state of the cache. The cache can be used when the state is equal to INITIALIZATION COMPLETE, 0×2. The locking of the SMS cache is done in a similar manner. If the SMS cache is already locked, the thread/process waits until the operation is completed and the SMS cache is unlocked. The thread/process will then update the second 4 bytes of the segment header 910 atomically and continue with the operation. After the operation has completed, it unlocks the SMS cache by atomically changing the value of the lock to UNLOCKED, 0×0.

As discussed above, the SMS cache supports variable length objects. This requires an efficient management of the shared memory segment. The memory heap is a segment of memory reserved for dynamic memory management. It operates as a pool of memory blocks that are allocated and freed as needed by applications. The heap is often divided into two regions: free memory blocks which are blocks of memory that are not currently in use and can be allocated to satisfy future requests, and allocated memory blocks which are blocks of memory that are currently assigned to an application or process. A metadata header is associated with each memory block to store information, such as the block size and status (free or allocated).

In the example implementation of the illustrative embodiment depicted in FIG. 9, the heap 930 of the SMS cache is divided into equally sized blocks. Each block has a size of MAX BLOCK SIZE. The number of blocks is calculated by dividing the size of the heap area 930 by the size of one block, which is a constant. The header of each block is of 1 byte. If the header has a value equal to 0×0, it indicates that the block is free, and if the value is equal to 0×1, it indicated that the block is allocated.

Since this version of the SMS cache uses a global lock on the entire cache, there is no need to for any synchronization on the heap manager. Whenever malloc is called, a “for” loop starting from the heap 930 start addr+HEADER SIZE is executed to check if the header is equal to 0 and return the pointer to the block is so, otherwise the process moves to the next block by adding MAX BLOCK SIZE to the pointer until the end of the heap area 930 is reached. When the free(ptr) function is called, the byte, pointed to by the ptr-HEADER SIZE (1 byte in the example implementation) back to 0×0, is updated. This indicates that the block is now usable for another entry.

### Policies

As shown in FIG. 8, policies, such as admission policies 830 and replacement policies 840, govern decisions regarding the usage of the SMS cache, such as which data to store, when to replace data, and how to maintain consistency between the SMS cache and the underlying data source. Cache replacement policies, such as replacement policies 840, determine which data item to evict from the SMS cache when it reaches capacity. Common strategies include Least Recently Used (LRU) which evicts the data item that has not been used for the longest time, First-In-First-Out (FIFO) which removes the oldest data item in the cache regardless of its usage frequency, Least Frequently Used (LFU) which evicts data that is accessed the least often over a period of time, and Random Replacement which chooses a data item to evict at random, offering simplicity but often suboptimal performance.

Admission policies, such as admission policies 830, determine whether an incoming data item should be stored in the SMS cache or bypass it altogether. These policies are particularly important when the SMS cache has limited capacity or when certain data may not offer sufficient benefit if cached. Common strategies include Always Admit which is the default approach where every incoming data item is cached, Frequency-Based Admission which admits data into the cache only if it surpasses a threshold of access frequency, Size-Aware Admission which takes the size of the data into account, prioritizing smaller items that offer a higher likelihood of reuse for the space they consume, Probabilistic Admission which introduces randomness into the admission process, caching only a subset of data based on a probability function, and Cost-Aware Admission which evaluates the cost of fetching the data from the source versus the benefit of storing it in the cache, and makes decisions accordingly.

The choice of cache policy significantly impacts system performance, influencing metrics such as hit rate, latency, and overall throughput. For instance, applications with predictable access patterns benefit from policies like LRU, while random access workloads may find limited benefit from sophisticated replacement strategies. For some illustrative embodiments of the SMS cache, a Random Replacement policy is used for the replacement policy 840 and an Always Admit policy is used for the admission policies 830.

### Serialization/Deserialization

As discussed above, object serialization and deserialization is a task that enables the efficient storage, transmission, and reconstruction of complex data structures. Serialization refers to the process of converting an in-memory object into a format suitable for storage or transfer. Serialization involves traversing an object's structure and encoding its state, including its fields and relationships to other objects. The choice of serialization format plays a key role in determining the efficiency, compatibility, and usability of the serialized data. Common formats include Binary Formats which are highly compact and efficient but less human-readable, Text-Based Formats which are more human-readable and platform-independent (e.g., JSON, XML, YAML), and Hybrid Formats which combining human readability and efficiency, such as BSON.

Serialization frameworks support customization through annotations or configuration files to control how specific fields are serialized (e.g., excluding transient data or managing version compatibility). During deserialization, the serialized data is parsed and mapped back to the original object's structure. This requires schema alignment between the serialized data and the target object. For strongly-typed systems (e.g., Java, C #), this process involves strict adherence to a predefined class structure, while in loosely-typed languages (e.g., Python, JavaScript), the process is more dynamic and flexible. Advanced deserialization mechanisms also handle challenges such as missing fields, version mismatches, or the presence of custom initialization logic.

In Java there are libraries which offer S/D functionality, each catering to different use cases and offering unique features. Popular libraries include Jackson which is a widely used library for JSON processing, offering fast and flexible serialization and deserialization capabilities, and which supports annotations to customize mappings and handles advanced features like polymorphism and custom type adapters, Gson which is another lightweight library for JSON handling, often favored for its simplicity and ease of use, as well as its support of custom serializers and deserializers, making it a versatile option for handling complex objects, Kryo which is nnown for its high performance, and use in scenarios where speed and efficiency are critical, with its specialization in binary serialization and ability to work well for compressing and transferring large datasets, and Java's Built-In Serialization which provides native serialization through the Serializable interface. While the Java Built-In Serialization is easy to use, it comes with drawbacks such as poor performance and limited flexibility, which often lead developers to prefer third-party libraries. In some illustrative embodiments of the SMS cache, the Jackson library is used since it is a default S/D library of Micronaut.

### Improvements to Baseline Implementation of SMS Cache

The above provides an example of some illustrative embodiments in which a more baseline implementation is presented. A number of improvements to this baseline implementation may be made in accordance with one or more additional illustrative embodiments, so as to achieve improved performance. For example, various modifications to the structure of the shared memory segment can be made which improve the concurrent performance of the SMS cache.

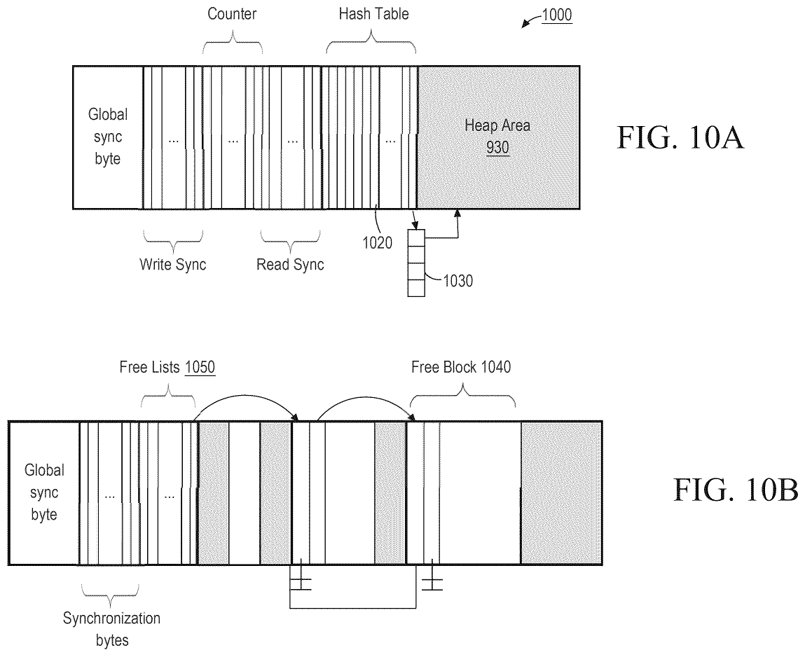

In some illustrative embodiments, the hash table 920 of the shared memory segment 900, as shown in FIG. 10A, is divided into “buckets” 1020 with each bucket containing a linked list 1030 of entries of a fixed size. The synchronization is done on individual buckets 1020 and not on the entire SMS cache 1000. Usage of the SMS cache 1000 by processes performing reads/writes entails the usage of read/write locks instead of a global lock on the entire SMS cache 1000. This improves the performance in the case of concurrent requests and brings the average waiting time for locks down since now a process does not have to wait for a read operation to finish. One thing to note is that the waiting time for writes is very dependent on the time it takes to finish the write operation since a write locks the bucket 1020 for all other operations. A faster write means a lower average waiting time.

It should be noted that in FIGS. 10A and 10B, the reference to global synch byte, counters, write sync, read sync, and synchronization bytes is referring to the mechanisms for locking sections of memory that are being written to. That is, since multiple applications or application instances are accessing the same memory, a mechanism is provided to use a portion of the cache for synchronization purposes. For example, if an application or application instance is writing to the cache, there is a need to lock the written to sections so that another application or application instance does not write to the same place. The synchronization bytes are used for that purpose. Similarly, when reading, it is not desirable to have another application or application instance evict the objects being read before the read is finished.

With regard to memory management, in the baseline implementation described above, the allocated blocks had a maximum size, which means that larger blocks cannot be allocated even if there is enough memory. Moreover, the time it takes to allocate a block increases with the number of allocated blocks since the baseline implementation iterates over all blocks. This could lead to high fragmentation and allocation time.

FIG. 10B shows the new allocator for the heap area, e.g., heap area 930 in FIG. 9. Free blocks 1040 are managed by using free lists 1050. The number of free lists 1050 is fixed (e.g., twice the number of cores). Each free lists 1050 is a double linked list of free blocks whose size is in the same range, e.g., 2 KB ranges (for example 0-2 KB, 2 KB-4 KB, and so on). This means that the illustrative embodiments can easily look for a free block 1040 big enough for a requested size. That is, the illustrative embodiments can ignore all the free lists 1050 which contain blocks in ranges smaller than the requested size. If, for example, there are no free blocks in a certain range, the process moves to the next free list 1050 until one that has a big enough free block 1040 is found. Each block has a header which contains the following information: the size of the block, the offset from the beginning of the heap area to the previous block in the free list, and the offset to the next block in the free list.

The synchronization is done on the free lists 1050 themselves. The free list 1050 is locked when a process is trying to add, remove, or find a block. This allows for modification of different free lists 1050 in parallel, e.g., when a process wants to allocate a very small and a very large block. When a block is found, it is firstly removed from its free list 1050. It could also happen that it is much larger than the requested size. In this case the block is divided into two blocks. The first block is exactly the requested size and it is returned to the requesting process, while the second block is inserted back into the free list 1050, based on its size, after the header of the block is updated with its new size.

When no free block is found, a lock of all the free lists 1050 is obtained, after waiting for the operations being done on them to finish, and a compression operation is performed. In this compression operation, iteration over all the blocks is performed and adjacent free blocks are merged. This will decrease fragmentation. After the compression operation is performed, the process will again try to find the block. If no block is not found a null result is returned.

With regard to the admission and replacement policies, in the baseline implementation described previously, the LRU policy ensures that the least recently accessed items are evicted first when space is needed, making it a simple yet effective choice for managing cache entries. In some illustrative embodiments, a TinyLFU policy may be used as the admission policy, where TinyLFU maintains a frequency sketch of accessed items, allowing it to make informed decisions about which items should be admitted into the SMS cache. By filtering out low-frequency items, TinyLFU helps prevent cache pollution, ensuring that valuable, frequently accessed entries are retained longer. TinyLFU uses a compact data structure, a Counting Bloom Filter, to store approximate frequency statistics of recently accessed items. The frequency count is maintained over a sliding window of recent accesses, ensuring that it adapts to changing workloads. When a get or put request is performed, the key is hashed to get different indexes for the counters. Each counter is increased by one and when it is approximated how often a key has been accessed, the illustrative embodiments can simply return the minimum between the counters obtained by hashing the key.

When a new item is accessed, the TinyLFU admission policy process compares its estimated frequency to that of the eviction candidate. If the new item has a higher frequency, it replaces the eviction candidate; otherwise, it is not admitted into the SMS cache. To prevent outdated frequency data from dominating decisions, the TinyLFU admission policy process periodically halves all frequency counters using a reset operation. This ensures that frequently accessed items in the past do not retain artificially high priority over time.

With regard to Serialization/Deserialization (S/D), in the baseline implementation S/D is the most expensive process and the main bottleneck of the SMS cache. For improved performance of the SMS cache, different libraries and different formats for serialization/deserialization, from that used in the baseline implementation, may be utilized. However, it has been recognized that the data being cached is not being sent to another system. To the contrary, the data is sent from one application instance to the SMS cache, and then is retrieved from the SMS cache by another application instance. Since both application instances are different instances of the same code, and they are running on the same serverless runtime, the system does not change between the application instances. This means that the most efficient format for performance is whatever format the serverless runtime and virtual machine uses internally to represent objects, e.g., what the GraalVM uses internally to represent objects. Thus, some illustrative embodiments can implement a “serializer” which goes over the object tree and “copies” all the objects “as they are”. This means using the GraalVM internal representation as the format. The deserialization would be a copy of the bytes followed by a patching of the pointers.

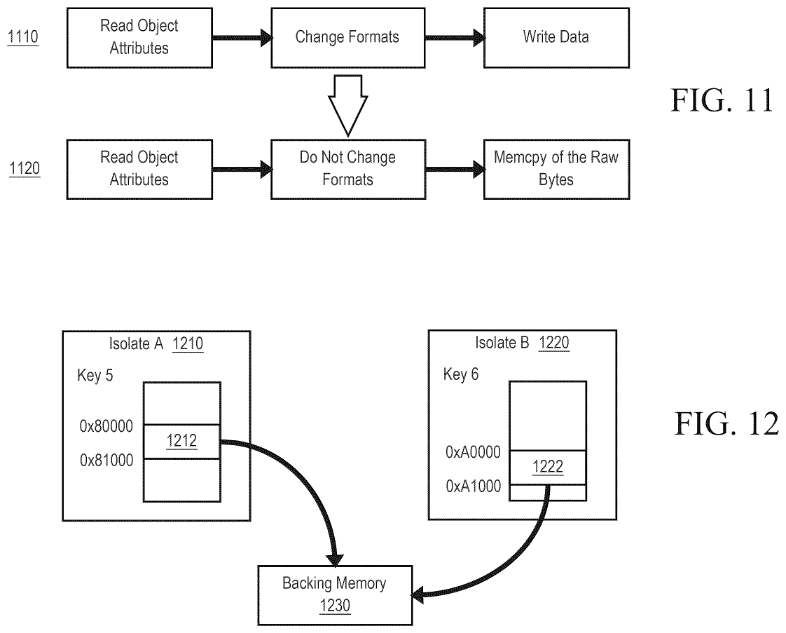

FIG. 11 shows the change in operations performed when using the GraalVM internal representation as the format. As shown in FIG. 11, the process progresses from a first process 1110 having to encode and decode the data to a second process 1120 which simply performs a copy over the raw bytes. This is much faster than the baseline implementation, however it requires a much tighter integration with the underlying systems and can be harder to port to other systems. Direct Heap Object Snapshotting and Sharing (DOSS) in the GraalVM can be used to go over all the objects in the object tree and copy them as-is, without any changes to the internal format. The “snapshot” can then be saved on disk and loaded back into the Java heap by another application instance. That is, DOSS creates a snapshot of an object tree (this is a copy of the object tree in another part of the Java heap), saves this copy on disk, and loads back the copy in the Java heap and patches the pointers. In the illustrative embodiments, instead of writing on disk, the object tree created by DOSS is copied to the SMS cache. This means that serialization is not being performed, but instead a copying of the raw representation of the object is being performed into the SMS cache. This improvement provides a much faster operation than other alternatives.

Improvements to the use of MPKs is also possible with various illustrative embodiments of the present invention. Applications that run on the same Visor are run as threads. This means that there needs to be a mechanism which serves to isolate application instances on the same Visor. As noted above, this mechanism is provided in the form of MPKs. Each thread/application instance is assigned one key and that key is used for the memory segments which are used by that application instances. Since MPKs are a scarce resource, it is important to be careful with how they are used.

FIG. 12 shows an example usage of MPKs in accordance with one or more illustrative embodiments. As shown in FIG. 12, the shared memory segment is mapped multiple times in different parts of the virtual memory. Since the shared memory segment will be mapped different times for each application instance, this means that it is not necessary to assign a key per shared memory segment, and instead the key of the application instance can be used. Each Isolate, e.g., Isolate 1210 and Isolate 1220, is assigned a key which is going to be used for its part of the virtual memory 1230. In the example of FIG. 12, it can be seen that Isolate 1210 has mapped the shared memory segment 1212 in the range 0x80000 to 0x81000, which is marked with the Key 5, and Isolate 1220 has mapped the shared memory segment 1222 in the range 0xA0000 to 0xA1000, which is marked with the Key 6. Since the backing memory 1230 is the same, changes done from Isolate 1210 can be seen from Isolate 1220. An important point is that Isolate 1210 cannot use the mapping of Isolate 1220 and vice versa. This means that the SMS cache solution can be used in GraalOS without any additional changes to its existing isolation model.

### example SMS Cache Process

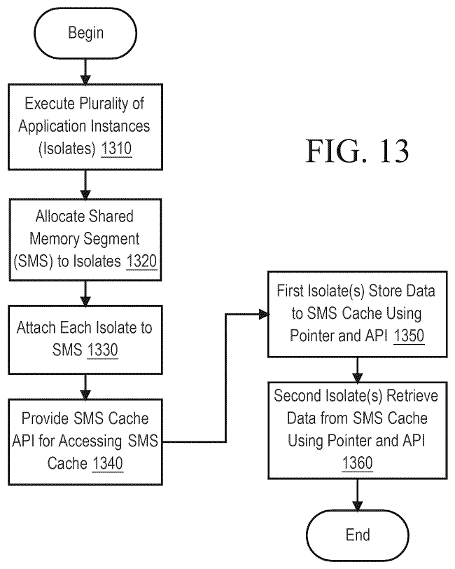

FIG. 13 provides an example flowchart outlining an example process or implementing a shared memory segment-based (SMS) cache in accordance with one illustrative embodiment. As shown in FIG. 13, the operation starts by executing a plurality of application instances of an application in a serverless runtime, where each application instance is executed as an Isolate with regard to other application instances (step 1310). The serverless runtime allocates a shared memory segment to the plurality of application instances (step 1320). The serverless runtime attaches each of the plurality of application instances to the shared memory segment (step 1330) and provides an application programming interface (API) through which the application instances can make customer system calls to the serverless runtime for accessing the shared memory segment (step 1340). A first application instance in the one or more application instances may then store a data object to the shared memory segment (SMS) as part of a cache to be shared between the application instances, using a pointer to the SMS and the API (step 1350). One or more second application instances in the plurality of application instances can then retrieve the data object from the SMS cache using the same pointer and the API (step 1360) without having to access the original data source of the cached data object, e.g., the backend database or the like. The operation then terminates. It should be appreciated that while the flowchart shows a termination, the process may be repeated for each access to the SMS cache for storing/retrieving data objects amongst the plurality of application instances.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

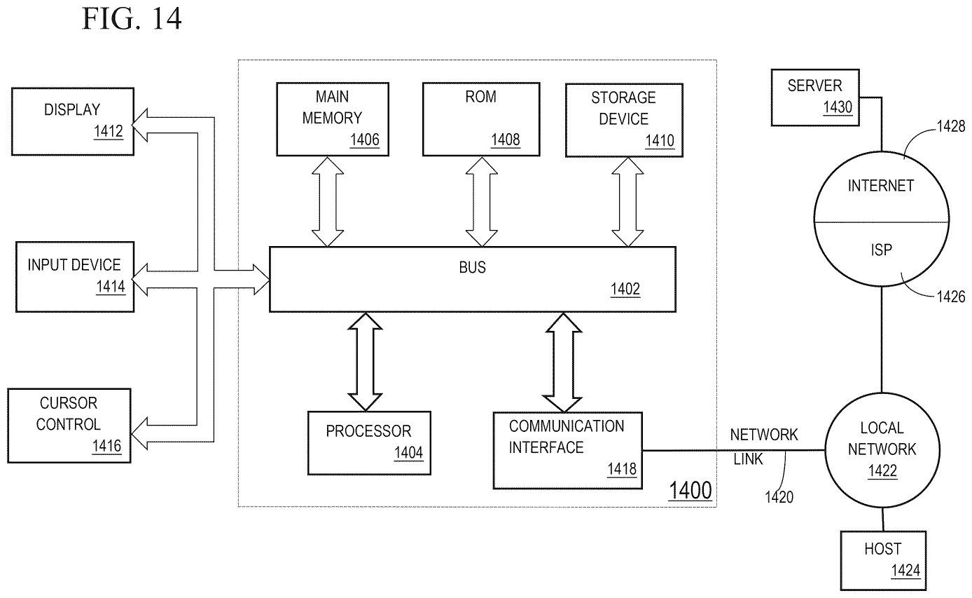

For example, FIG. 14 is a block diagram that illustrates a computer system 1400 upon which an embodiment of the invention may be implemented. Computer system 1400 includes a bus 1402 or other communication mechanism for communicating information, and a hardware processor 1404 coupled with bus 1402 for processing information. Hardware processor 1404 may be, for example, a general purpose microprocessor.

Computer system 1400 also includes a main memory 1406, such as a random access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Such instructions, when stored in non-transitory storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk, optical disk, or solid-state drive is provided and coupled to bus 1402 for storing information and instructions.

Computer system 1400 may be coupled via bus 1402 to a display 1412, such as a cathode ray tube (CRT), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane.

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to processor 1404 executing one or more sequences of one or more instructions contained in main memory 1406. Such instructions may be read into main memory 1406 from another storage medium, such as storage device 1410. Execution of the sequences of instructions contained in main memory 1406 causes processor 1404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1410. Volatile media includes dynamic memory, such as main memory 1406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid-state drive of a remote computer. The remote computer can load the instructions into its dynamic memory and send the instructions over a telephone line using a modem. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### Software Overview

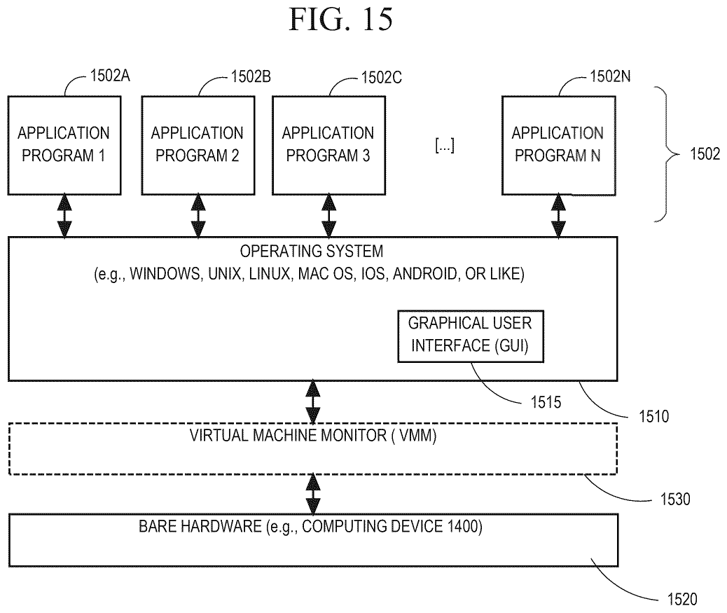

FIG. 15 is a block diagram of a basic software system 1500 that may be employed for controlling the operation of computer system 1400 upon which aspects of the illustrative embodiments may be implemented. Software system 1500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1500 is provided for directing the operation of computer system 600. Software system 1500, which may be stored in system memory (RAM) 606 and on fixed storage (e.g., hard disk or flash memory) 610, includes a kernel or operating system (OS) 1510.

The OS 1510 manages low-level aspects of computer operation, including managing execution of processes, memory allocation, file input and output (I/O), and device I/O. One or more application programs, represented as 1502A, 1502B, 1502C . . . 1502N, may be “loaded” (e.g., transferred from fixed storage 610 into memory 606) for execution by the system 1500. The applications or other software intended for use on computer system 600 may also be stored as a set of downloadable computer-executable instructions, for example, for downloading and installation from an Internet location (e.g., a Web server, an app store, or other online service).

Software system 1500 includes a graphical user interface (GUI) 1515, for receiving user commands and data in a graphical (e.g., “point-and-click” or “touch gesture”) fashion. These inputs, in turn, may be acted upon by the system 1500 in accordance with instructions from operating system 1510 and/or application(s) 1502. The GUI 1515 also serves to display the results of operation from the OS 1510 and application(s) 1502, whereupon the user may supply additional inputs or terminate the session (e.g., log off).

OS 1510 can execute directly on the bare hardware 1520 (e.g., processor(s) 604) of computer system 600. Alternatively, a hypervisor or virtual machine monitor (VMM) 1530 may be interposed between the bare hardware 1520 and the OS 1510. In this configuration, VMM 1530 acts as a software “cushion” or virtualization layer between the OS 1510 and the bare hardware 1520 of the computer system 600.

VMM 1530 instantiates and runs one or more virtual machine instances (“guest machines”). Each guest machine comprises a “guest” operating system, such as OS 1510, and one or more applications, such as application(s) 1502, designed to execute on the guest operating system. The VMM 1530 presents the guest operating systems with a virtual operating platform and manages the execution of the guest operating systems.

In some instances, the VMM 1530 may allow a guest operating system to run as if it is running on the bare hardware 1520 of computer system 600 directly. In these instances, the same version of the guest operating system configured to execute on the bare hardware 1520 directly may also execute on VMM 1530 without modification or reconfiguration. In other words, VMM 1530 may provide full hardware and CPU virtualization to a guest operating system in some instances.

In other instances, a guest operating system may be specially designed or configured to execute on VMM 1530 for efficiency. In these instances, the guest operating system is “aware” that it executes on a virtual machine monitor. In other words, VMM 1530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements, and provides a cloud computing system runtime, i.e., a framework that provides the environment for applications to execute using cloud computing system resources, services, and infrastructure. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability. Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
executing, in a cloud computing system runtime, a plurality of application instances of a same application, wherein each application instance executes in an isolated manner from each other application instance in the plurality of application instances;
allocating, to the plurality of application instances, a shared memory segment for caching data used by the plurality of application instances;
attaching, by the cloud computing system runtime, each application instance in the plurality of application instances, to the shared memory segment;
storing, by one or more first application instances of the plurality of application instances, via a first custom call to the cloud computing system runtime, data to a cache implemented in the shared memory segment; and
retrieving, by one or more second application instances of the plurality of application instances, via a second custom call to the cloud computing system runtime, cached data from the cache without accessing an original data source of the cached data to obtain the cached data.

2. The method of claim 1, wherein the cloud computing system runtime is a serverless runtime.

3. The method of claim 1, wherein allocating the shared memory segment comprises providing, to an application instance, a pointer to the shared memory segment, and wherein the first custom call and second custom call reference the pointer to the shared memory segment.

4. The method of claim 1, wherein communication between the cloud computing system runtime and the application instances in the plurality of application instances is performed using one or more custom system calls (syscall) that expose internal features of the cloud computing system runtime to the application instances which specify a pointer to the shared memory segment.

5. The method of claim 1, wherein the application instances of the plurality of application instances access the cache implemented in the shared memory segment via a modular application framework providing an application programming interface (API) comprising a PUT function, a GET function, and an INVALIDATE function.

6. The method of claim 1, wherein data stored to the cache is a data object, and wherein storing the data to the cache comprises serializing the data object, and wherein retrieving the cached data from the cache comprises deserializing the cached data back into a corresponding data object.

7. The method of claim 6, wherein serializing the data object is achieved by copying an internal representation of an object tree, corresponding to the serverless runtime, of the data object to the cache, and wherein deserializing the cached data comprise copying of bytes followed by patching of pointers.

8. The method of claim 1, wherein the shared memory segment stores cache management data structures for managing the cache implemented in the shared memory segment, and wherein the management data structures comprise the entries of the cache, the keys and values, and the admission policy and replacement policy data structures.

9. The method of claim 1, wherein the shared memory segment is a Managed Global Area (MGA) memory segment of a database architecture.

10. The method of claim 1, wherein the data stored in the cache is metadata for business logic retrieved from a database management system, wherein each application instance of the plurality of application instances uses the metadata to perform business logic operations.

11. The method of claim 1, wherein the application instances in the plurality of application instances are isolated from each other application instance in the plurality of application instances based on an allocation of memory protection keys (MPKs) to the application instances that enforce isolation of application instances, and wherein access to the cache is mediated based on the MPKs allocated to the application instances.

12. The method of claim 1, wherein the plurality of application instances are co-located on a same node or host computing device.

13. The method of claim 1, wherein the cloud computing system runtime comprises a database management system for a database system from which the data that is stored in the cache is obtained.

14. The method of claim 1, wherein the plurality of application instances is one of a plurality of sets of application instances, wherein different shared memory segments are allocated to different ones of the sets of application instances, and wherein each set of application instances uses their corresponding allocated shared memory segment to implement a corresponding cache for that set of application instances.

15. One or more non-transitory computer-readable media storing instructions which, when executed by one or more processors, cause performance of:
executing, in a cloud computing system runtime, a plurality of application instances of a same application, wherein each application instance executes in an isolated manner from each other application instance in the plurality of application instances;
allocating, to the plurality of application instances, a shared memory segment for caching data used by the plurality of application instances;
attaching, by the cloud computing system runtime, each application instance in the plurality of application instances, to the shared memory segment;
storing, by one or more first application instances of the plurality of application instances, via a first custom call to the cloud computing system runtime, data to a cache implemented in the shared memory segment; and
retrieving, by one or more second application instances of the plurality of application instances, via a second custom call to the cloud computing system runtime, cached data from the cache without accessing an original data source of the cached data to obtain the cached data.

16. The one or more non-transitory computer-readable media of claim 15, wherein the cloud computing system runtime is a serverless runtime.

17. The one or more non-transitory computer-readable media of claim 15, wherein the application instances of the plurality of application instances access the cache implemented in the shared memory segment via a modular application framework providing an application programming interface (API) comprising a PUT function, a GET function, and an INVALIDATE function.

18. The one or more non-transitory computer-readable media of claim 15, wherein the shared memory segment stores cache management data structures for managing the cache implemented in the shared memory segment, and wherein the management data structures comprise the entries of the cache, the keys and values, and the admission policy and replacement policy data structures.

19. The one or more non-transitory computer-readable media of claim 15, wherein the shared memory segment is a Managed Global Area (MGA) memory segment of a database architecture.

20. An apparatus, comprising:
a processor; and
a memory coupled to the processor, wherein the memory comprises instructions which, when executed by the processor, cause the processor to execute the process comprising:
executing, in a cloud computing system runtime, a plurality of application instances of a same application, wherein each application instance executes in an isolated manner from each other application instance in the plurality of application instances;
allocating, to the plurality of application instances, a shared memory segment for caching data used by the plurality of application instances;
attaching, by the cloud computing system runtime, each application instance in the plurality of application instances, to the shared memory segment;
storing, by one or more first application instances of the plurality of application instances, via a first custom call to the cloud computing system runtime, data to a cache implemented in the shared memory segment; and
retrieving, by one or more second application instances of the plurality of application instances, via a second custom call to the cloud computing system runtime, cached data from the cache without accessing an original data source of the cached data to obtain the cached data.
